(19) United States
(12) Patent Application Publication
(10) Pub. No.: US 2024/0124011 A1
(43) Pub. Date: Apr. 18, 2024

(54) SYSTEM FOR BLIND SPOT AVOIDANCE AND A METHOD FOR AVOIDING TRAVELING IN A BLIND SPOT

(71) Applicant: ZF CV Systems Europe BV, Brussels (BE)

(72) Inventors: Hussein Alzuhd, Beverly Hills, MI (US); Erik Hakala, Greensboro, NC (US)

(21) Appl. No.: 18/047,178

(22) Filed: Oct. 17, 2022

(51) Int. Cl. B60W 50/14; B60W 30/14; B60W 40/04; B60W 60/00

(52) U.S. Cl. CPC B60W 50/14; B60W 30/146; B60W 40/04; B60W 60/0015; B60W 2050/143; B60W 2050/146; B60W 2554/80

(57) ABSTRACT

A blind spot avoidance system for a vehicle includes a sensor configured to detect a third-party vehicle traveling in an adjacent lane. A control unit of the system is configured to determine whether the vehicle is traveling in a blind spot region of the third-party vehicle to output a signal indicating that the vehicle is in the blind spot when the vehicle is in the blind spot region for more than a predetermined amount of time. A method for avoiding traveling in a blind spot of a third-party vehicle includes detecting the third-party vehicle in an adjacent lane via a sensor of a vehicle, determining whether the vehicle is in a blind spot of the third-party vehicle, and, outputting a signal when the vehicle is in the blind spot of the third-party vehicle for more than a predetermined amount of time.

### TECHNICAL FIELD

The disclosure relates to a system for blind spot avoidance and a method for avoiding traveling in a blind spot of another vehicle.

### BACKGROUND

The windshield and other windows in conjunction with a rearview mirror and side mirrors enable a driver of a vehicle to observe and examine their surroundings. However, as a result for example of the driver's forward orientation, the frame of the vehicle, the placement and orientation of the mirrors, and other areas around the vehicle may be restricted from view or difficult to view for the driver. Regions toward the rear of the vehicle on either side are often particularly restricted from the driver's view such that they are generally referred to as blind spots. In order to determine whether another vehicle is in a blind spot, a driver needs to turn their head while driving and divert their attention from what is ahead of the vehicle. Whether another vehicle is present in a blind spot is of particular importance when a vehicle is changing lanes on a multi-lane road.

U.S. Pat. No. 7,504,932 B2 discloses a method for monitoring blind spots of a vehicle and alerting the driver to the possible presence of another vehicle in their blind spot. By alerting the driver to the presence of another vehicle in their blind spot, for example, during or prior to a lane change, a collision with the vehicle in the blind spot can be avoided.

Drivers can be unaware they are occupying another vehicle's blind spot. Traveling and remaining in the blind spot of another vehicle increases the risk for a collision between the vehicles. Current blind spot detection only alerts the driver if another vehicle is in their own blind spot. When passing or being passed, traveling through a blind spot of another vehicle cannot be avoided. However, remaining in a blind spot increases the risk of an accident. When remaining in a blind spot, the other driver may engage in a lane change without checking their blind spot.

Further, while a driver may notice a vehicle approaching from behind via the rearview and side mirrors, if the vehicle remains in the blind spot, the driver may forget the vehicle is there.

### SUMMARY

It is an object of the disclosure to provide a blind spot avoidance system for a vehicle for avoidance of loitering in a blind spot of another vehicle.

The aforementioned object can, for example, be achieved via a blind spot avoidance system for a vehicle according to the disclosure. The blind spot avoidance system includes a sensor configured to detect a third-party vehicle traveling in an adjacent lane and a control unit configured to determine whether the vehicle is traveling in a blind spot region of the third-party vehicle. The control unit is further configured to output a signal indicating that the vehicle is in the blind spot when the vehicle is in the blind spot region for more than a predetermined amount of time.

According to various embodiments, at least one of the sensor and a further sensor is configured to determine whether the vehicle has a forward target within a predetermined distance. The control unit is configured to output a signal when the vehicle is in the blind spot region for more than the predetermined amount of time and the vehicle has no forward target within a predetermined time gap.

According to various embodiments, the signal outputted by the control unit is configured to cause a warning to be displayed to a driver of the vehicle.

According to various embodiments, the signal outputted by the control unit is configured to cause an auditory warning to be generated for a driver of the vehicle.

According to various embodiments, the signal outputted by the control unit is configured to cause a driver's assistance unit or an autonomous vehicle control to move the vehicle out of the blind spot.

According to various embodiments, the signal outputted by the control unit is configured to cause the vehicle to decelerate so as to exit the blind spot.

According to various embodiments, the blind spot avoidance system is a component of an autonomous driving system.

According to various embodiments, the control unit is configured to output a signal when the vehicle is in the blind spot region for more than the predetermined amount of time, the vehicle has no forward target within the predetermined time gap, and the vehicle is traveling above a threshold speed.

According to various embodiments, the host vehicle has a front end and the control unit is configured to determine whether the vehicle is in the blind spot region of the third-party vehicle by determining whether the front end of the vehicle at least one of overlaps and is within a predetermined distance of overlapping with the third-party vehicle in the adjacent lane.

It is a further object of the disclosure to provide a method for avoiding traveling in a blind spot of a third-party vehicle. The aforementioned object can, for example, be achieved via a method for avoiding traveling in a blind spot of a third-party vehicle according to the disclosure. The method includes: detecting the third-party vehicle in an adjacent lane via a sensor of a vehicle, determining whether the vehicle is in a blind spot of the third-party vehicle, and, outputting a signal when the vehicle is in the blind spot of the third-party vehicle for more than a predetermined amount of time.

According to various embodiments, the method further includes determining whether the vehicle has a forward target within a predetermined time gap via at least one of the sensor and a further sensor. The signal is outputted when the vehicle is in the blind spot region for more than the predetermined amount of time and no forward target within the predetermined time gap is determined.

According to various embodiments, the method further includes decelerating the vehicle so as to exit the blind spot of the third-party vehicle.

According to various embodiments, the method further includes providing the signal to a driver's assistance unit or an autonomous driving system.

According to various embodiments, determining whether the vehicle is in the blind spot of the third-party vehicle includes: determining whether a front end of the vehicle at least one of overlaps or is within a predetermined distance of overlapping with the third-party vehicle in the adjacent lane.

It is a further object of the disclosure to provide a control unit for avoiding traveling in blind spots of a third-party vehicle.

This object can, for example, be achieved via an electronic control unit configured to receive data from at least one environment detection sensor and which can be connected via one or more communication busses to at least one electronic control unit of a drive system of a vehicle and an electronic processing unit of an infotainment system of the vehicle. The electronic control unit is adapted to evaluate data from the at least one environment sensor and to transmit at least one of communication messages to the electronic processing unit of the infotainment system and control commands to at least one electronic control unit of the drive system in such a way that a method of the disclosure is performed.

### BRIEF DESCRIPTION OF THE DRAWINGS

The invention will now be described with reference to the drawings wherein:

FIG. 1 shows a vehicle and blind spots associated with the vehicle;

FIG. 2 shows a host vehicle with a blind spot avoidance system in a blind spot region of another vehicle;

FIG. 3 shows a host vehicle with a blind spot avoidance system traveling in a denser traffic environment;

FIG. 4 shows host vehicles with blind spot avoidance systems in various locations relative to other traffic participants;

FIG. 5 shows a host vehicle with a blind spot avoidance system;

FIG. 6 shows a flow chart of a method for blind spot avoidance;

FIG. 7 shows a flow chart of a method for blind spot avoidance; and,

FIG. 8 shows a control unit of an advanced driver-assistance system configured for blind spot avoidance.

### DESCRIPTION OF THE PREFERRED EMBODIMENTS

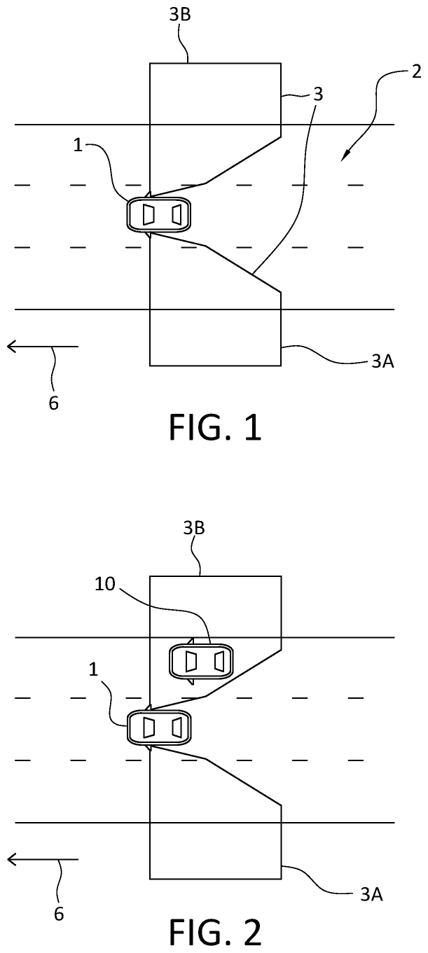

FIG. 1 shows a vehicle 1 traveling on a road 2 in travel direction 6. The vehicle 1 has blind spots 3. The blind spots 3 include a left-side blind spot 3A and a right-side blind spot 3B. The size and configuration of the blind spots result from the seating position of the driver, the orientation of the mirrors, the construction of the vehicle, driving conditions including speed and the like, etc. As a result of the aforementioned factors, the driver of the vehicle must rotate their head to the blind spot in order to determine whether an obstacle is present. For example, when changing lanes on a multi-lane road, a driver should visually check their blind spot to ensure no vehicle is present prior to conducting the lane change. When changing lanes with another vehicle present in a blind spot, the chances of a collision with the other vehicle are increased.

Correspondingly, traveling in a blind spot of another vehicle, especially for an extended period of time, increases the chances of a collision resulting, for example, from a lane change of the other vehicle. Further, a driver who is unaware that a further vehicle 10 is in their blind spot may, for example, also operate their vehicle 1 with less attention, in particular to the relative positioning of their vehicle 1 in the travel lane. This can also result in a collision or force the driver of the further vehicle 10 to evade the vehicle 1 when the unaware driver is encroaching in the lane of the further vehicle 10.

FIG. 2 shows a host vehicle 10 in a blind spot region 3B of the vehicle 1. In this relative location to vehicle 1, the driver of vehicle 1 cannot see the host vehicle 10 via sideview or rearview mirrors and, thus, must rotate their head to determine whether another vehicle is in their blind spot region 3B. Accordingly there is an increased likelihood of a collision between the vehicle 1 and the host vehicle 10, especially if the host vehicle 10 remains in the blind spot 3. While completely avoiding the blind spot regions of the vehicle 1 is not always possible due to vehicles traveling at different speeds, vehicles passing each other, traffic slowdowns in one of the lanes and the like, it is undesirable to travel in the blind spot region 3 of another vehicle 1 for an extended period of time, especially when traffic is such that it can be avoided.

When the host vehicle 10 spends an extended amount of time in the blind spot of vehicle 1, the driver of vehicle 1 may, for example, forget the host vehicle 10 is there by the time the vehicle 1 intends to change lanes into the lane occupied by the host vehicle 10.

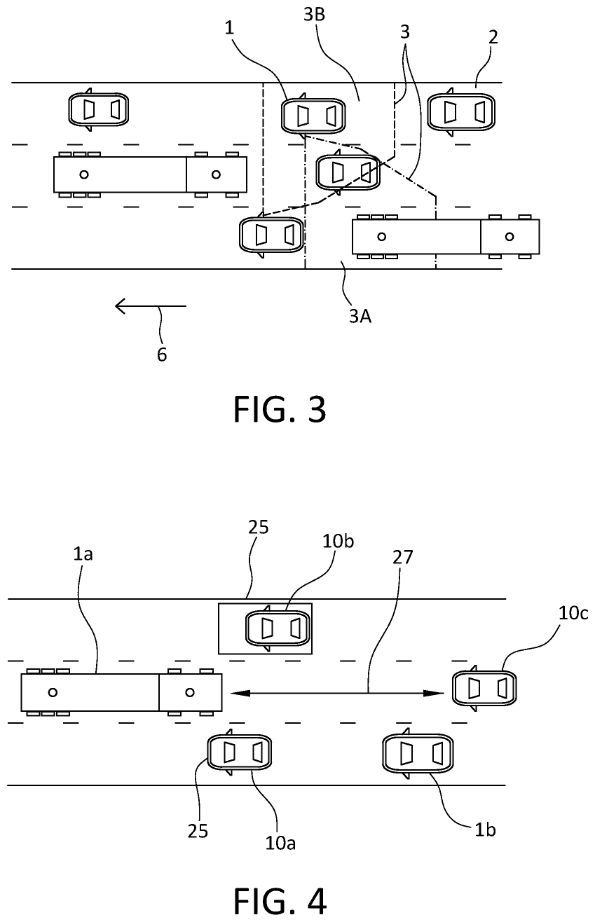

FIG. 3 shows a traffic situation wherein outputting a warning that the host vehicle 10 is traveling in a blind spot region 3 of another vehicle 1 could be undesirable. In a situation as shown in FIG. 3, it may not be possible or desirable to avoid traveling in a blind spot 3 of another vehicle 1.

According to various embodiments, a blind spot avoidance system determines whether the host vehicle 10 is traveling in a blind spot of another vehicle 1. A control unit 20 warns the driver of the host vehicle 10 that they are traveling in the blind spot of another vehicle 1. According to an aspect of the disclosure, the warning is only outputted if the host vehicle 10 remains in the blind spot 3 of the third-party vehicle 1 for more than a predetermined amount of time, for example, 10 seconds. The predetermined amount of time can be adapted for specific driving conditions and/or be adjustable.

According to various embodiments, the driver of the host vehicle 10 is alerted to the presence of the host vehicle 10 in the blind spot 3 of another vehicle 1 after the host vehicle 10 has remained in the blind spot 3 of the other vehicle 1 for a predetermined period of time. Accordingly, the driver is not alerted to their presence in the blind spot 3 of another vehicle 1 until after the predetermined amount of time has passed. This avoids alerting the driver to their brief presence in the blind spot 3 of the other vehicle 1 when, for example, passing the other vehicle 1 or when the other vehicle 1 is passing the host vehicle 10.

FIG. 4 shows a first host vehicle 10a in a blind spot 3 of vehicle 1a with the front edge 26 of the first host vehicle 10a overlapping with the vehicle 1a in an adjacent lane. When the first host vehicle 10a remains in the shown location for more than a predetermined amount of time, the blind spot avoidance system 5 can act, that is, warn the driver of the first host vehicle 10a, and/or cause a driver assistance system and/or autonomous driving system to move the first host vehicle 10a out of the blind spot region of vehicle 1a. A second host vehicle 10b does not overlap with the vehicle 1a, however, the second host vehicle 10b can be considered to be in a buffer zone 25, that is, within a predetermined distance of overlapping with vehicle 1a. If second host vehicle 10b remains in the same relative location to vehicle 1a, the blind spot avoidance system 5 can act when a buffer zone 25 is considered by the blind spot avoidance system 5.

FIG. 4 further shows a third host vehicle 10c with a time gap 27 to vehicle 1a while being in a blind spot region 3 of the vehicle 1b. According to various embodiments, when the time gap 27 is greater than a predetermined period, and the third host vehicle 10c is in the blind spot 3 of the vehicle 1b for more than a predetermined amount of time, the blind spot avoidance system 5 outputs a signal.

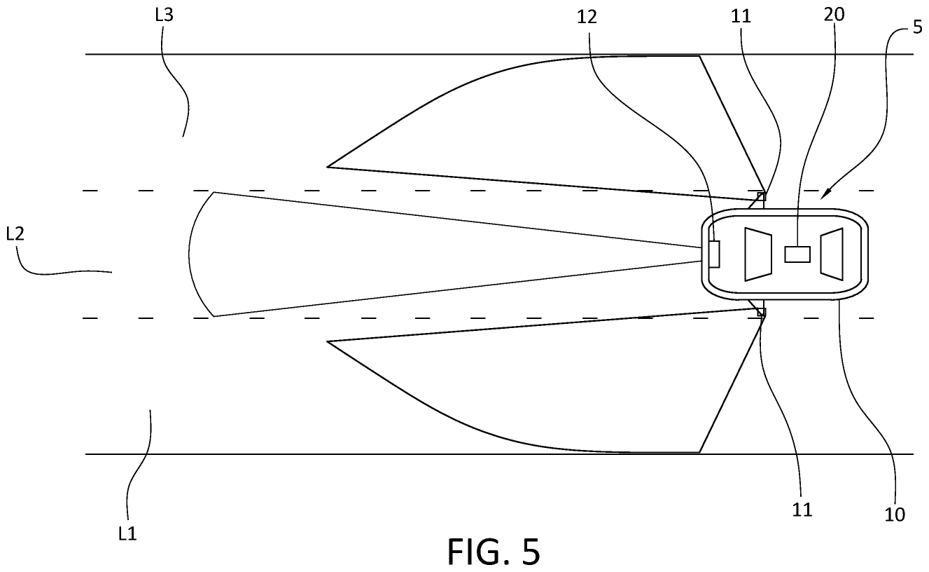

FIG. 5 shows a host vehicle 10 having a blind spot avoidance system 5 traveling in lane L2. According to various embodiments, the blind spot avoidance system 5 includes a first sensor 11 for determining whether another vehicle is in an adjacent lane L1 on a first side of the host vehicle 10. The blind spot avoidance system 5 can further include a second sensor 11 for determining whether another vehicle is in an adjacent lane L3 on a second side of the host vehicle 10. The sensor 11 can be configured to determine the location of the third-party vehicle in relation to the host vehicle 10. A control unit 20 uses data provided by the sensor 11 to determine whether the host vehicle 10 is in a blind spot region 3. The sensor 11 can, for example, be a blind spot sensor, an environmental sensor, a camera, a radar sensor, a lidar sensor, or a camera with a wide-angle field of view, et cetera.

According to various embodiments, a criteria for determining the presence of the host vehicle 10 in the blind spot 3 of a third-party vehicle 1 is an overlap of the third-party vehicle 1 with the front end 26 of the host vehicle 10. Further, a buffer zone 25 can be included wherein the host vehicle 10 is determined to be within the blind spot region when the front end 26 of the host vehicle 10 is within a predetermined distance of the rear portion of the third-party vehicle 1. Accordingly, it can be determined that the host vehicle is in a blind spot 3 when there is no overlap with the third-party vehicle. The predetermined distance can be configured to be adjustable.

According to various embodiments, the blind spot avoidance system 5 can include a forward sensor 12 configured to determine if the host vehicle 10 has a forward target, that is another vehicle is ahead of the host vehicle 10, in particular in the same lane.

In certain traffic situations, it may not be possible or expedient to avoid the blind spot of a third-party vehicle, such as in heavier traffic where vehicles in adjacent lanes remain adjacent to each other, for example, due to a lack of forward traffic movement. In such situations it can be undesirable to warn the driver as there is no practical manner in which being in a blind spot region 3 of a third-party vehicle 1 can be avoided. The control unit 20 can be configured to output a warning only when the host vehicle 10 is in a blind spot region 3 of a third-party vehicle 1 and does not have a forward target within a predetermined distance and/or time gap 27. A time gap 27 is an amount of time until the host vehicle 1 would reach the forward target at its current speed. For example, a time gap 27 of less than three seconds can be used as a threshold for not outputting the signal. When traveling at low speeds, for example, in traffic or when exiting a parking lot at a large event or the like, a warning can also be suppressed to avoid irritating the driver or providing the driver with unnecessary information. For example, the control unit can be configured to not output a blind spot avoidance signal when traveling less than, for example, 15 miles per hour.

The signal outputted by the control unit 20 can trigger an auditory and/or visual warning. For example, “Avoid driving in blind spots” can be output as an auditory signal or a symbol/text can be displayed in a dashboard or in a screen of the host vehicle 10. The warning to the driver can also be in the form of a vibration, for example, of the steering wheel.

According to various embodiments, the signal is outputted to a driver's assistance unit which assists the driver in driving the host vehicle 10. Alternatively, the signal can be output to an autonomous driving module of the host vehicle 10. The signal can, for example, cause the host vehicle 10 to decelerate so as to exit the blind spot region 3. Alternatively, the signal could also cause the host vehicle 10 to accelerate out of the blind spot 3 and/or change lanes to a non-adjacent lane or otherwise maneuver out of the blind spot region 3 of the third-party vehicle 1.

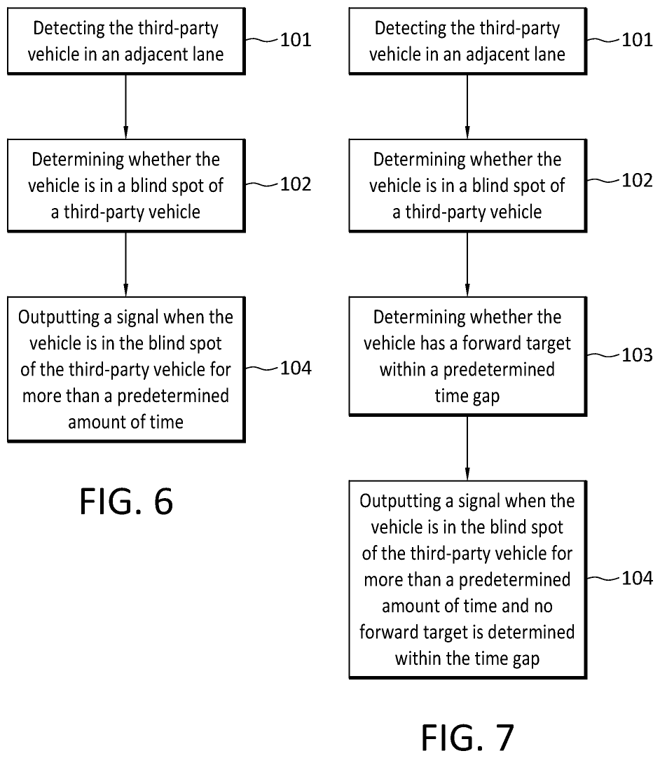

FIG. 6 shows a flow chart of a method for avoiding traveling in a blind spot of a third-party vehicle. In the method, in a first step 101, it is detected via a sensor whether a third-party vehicle 1 is in an adjacent lane of the host vehicle 10. In a second step 102, it is determined whether the vehicle 10 is in a blind spot 3 of the third-party vehicle 1. In a third step 104, a signal is outputted when the host vehicle 10 is in the blind spot 3 of the third-party vehicle 1 for more than a predetermined amount of time.

FIG. 7 shows a further embodiment of the method of FIG. 6, wherein, in a step 103, it is determined whether the vehicle 10 has a forward target within a predetermined time gap 27. According to the method of FIG. 7, the signal is outputted when the host vehicle 10 is in the blind spot 3 for more than the predetermined amount of time and no forward target within the predetermined time gap 27 is determined.

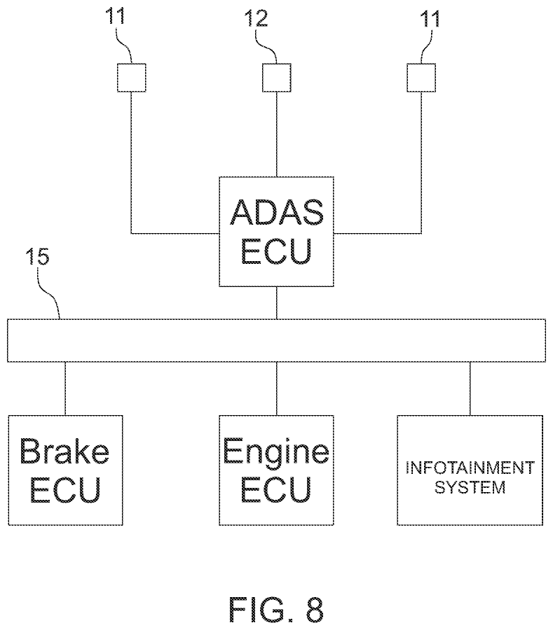

FIG. 8 shows an embodiment of an advanced driver-assistance system electronic control unit ADAS-ECU connected to sensors 11 and a forward sensor 12. The ADAS-ECU can alternatively be connected to the sensors 11 and the forward sensor 12 via a communication bus 15, for example, a CAN bus (Controller Area Network). The ADAS-ECU is configured to receive data from sensors 11 and forward sensor 12. From the data received from the sensors 11, the ADAS-ECU determines whether the vehicle is traveling in a blind spot of another vehicle. Further, the ADAS-ECU can determine a time gap between another vehicle traveling in front of the vehicle having the ADAS-ECU and the vehicle having the ADAS-ECU. According to various embodiments, the ADAS-ECU includes a processor and a non-transitory computer readable medium. The non-transitory computer readable medium can include program code stored thereon for executing methods of the disclosure.

In the embodiment shown in FIG. 8, the ADAS-ECU is further connected to a brake electronic control unit Brake-ECU for controlling the brakes of the vehicle and an engine electronic control unit Engine ECU for controlling the engine. If the ADAS-ECU determines that the vehicle is traveling in the blind spot of another vehicle, the ADAS-ECU can send a signal, such as a control command and/or communication message, to the Engine ECU to accelerate the vehicle or to the Brake ECU to decelerate the vehicle so as to cause the vehicle to exit the blind spot. In the embodiment shown in FIG. 8, the Brake ECU and the Engine ECU are connected to the ADAS-ECU via the communication bus 15. A warning or other message or graphic can be displayed to a driver of the vehicle via an infotainment system in response to signals received from the ADAS-ECU. The warning or message to the driver can, for example, warn the driver that the vehicle is traveling in a blind spot, instruct the driver to manually exit the blind spot, and/or inform the driver that the ADAS-ECU will cause the vehicle to exit the blind spot.

It is understood that the foregoing description is that of the preferred embodiments of the invention and that various changes and modifications may be made thereto without departing from the spirit and scope of the invention as defined in the appended claims.

What is claimed is:

1. A blind spot avoidance system for a vehicle, the blind spot avoidance system comprising:
a sensor configured to detect a third-party vehicle traveling in an adjacent lane;
a control unit configured to determine whether the vehicle is traveling in a blind spot region of the third-party vehicle; and,
said control unit being further configured to output a signal indicating that the vehicle is in the blind spot when the vehicle is in the blind spot region for more than a predetermined amount of time.

2. The blind spot avoidance system of claim 1, wherein at least one of said sensor and a further sensor is configured to determine whether the vehicle has a forward target within a predetermined distance; and, said control unit is configured to output said signal when the vehicle is in the blind spot region for more than the predetermined amount of time and the vehicle has no forward target within a predetermined time gap.

3. The blind spot avoidance system of claim 1, wherein said signal is configured to cause a warning to be displayed to a driver of the vehicle.

4. The blind spot avoidance system of claim 1, wherein said signal is configured to cause an auditory warning to be generated for a driver of the vehicle.

5. The blind spot avoidance system of claim 1, wherein said signal is configured to cause a driver's assistance unit or an autonomous vehicle control to move the vehicle out of the blind spot.

6. The blind spot avoidance system of claim 2, wherein said signal is configured to cause a driver's assistance unit or an autonomous vehicle control to move the vehicle out of the blind spot region.

7. The blind spot avoidance system of claim 2, wherein said signal is configured to cause the vehicle to decelerate so as to exit the blind spot.

8. The blind spot avoidance system of claim 1, wherein the blind spot avoidance system is a component of an autonomous driving system.

9. The blind spot avoidance system of claim 2, wherein said control unit is configured to output said signal when the vehicle is in the blind spot region for more than the predetermined amount of time, the vehicle has no forward target within the predetermined time gap, and the vehicle is traveling above a threshold speed.

10. The blind spot avoidance system of claim 1, wherein the host vehicle has a front end; and, said control unit is configured to determine whether the vehicle is in the blind spot region of the third-party by determining whether the front end of the vehicle at least one of overlaps and is within a predetermined distance of overlapping with the third-party vehicle in the adjacent lane.

11. A method for avoiding traveling in a blind spot of a third-party vehicle, the method comprising:
detecting the third-party vehicle in an adjacent lane via a sensor of a vehicle;
determining whether the vehicle is in a blind spot of the third-party vehicle; and,
outputting a signal when the vehicle is in the blind spot of the third-party vehicle for more than a predetermined amount of time.

12. The method of claim 11 further comprising:
determining whether the vehicle has a forward target within a predetermined time gap via at least one of the sensor and a further sensor; and,
wherein the signal is outputted when the vehicle is in the blind spot region for more than the predetermined amount of time and no forward target within the predetermined time gap is determined.

13. The method of claim 12 further comprising decelerating the vehicle so as to exit the blind spot of the third-party vehicle.

14. The method of claim 11 further comprising providing the signal to a driver's assistance unit or an autonomous driving system.

15. The method of claim 11, wherein said determining whether the vehicle is in the blind spot of the third-party vehicle includes: determining whether a front end of the vehicle at least one of overlaps or is within a predetermined distance of overlapping with the third-party vehicle in the adjacent lane.

16. The method of claim 12, wherein said determining whether the vehicle is in the blind spot of the third-party vehicle includes: determining whether a front end of the vehicle at least one of overlaps or is within a predetermined distance of overlapping with the third-party vehicle in the adjacent lane.

17. An electronic control unit configured to receive data from at least one environment detection sensor and which can be connected via one or more communication busses to at least one electronic control unit of a drive system of a vehicle and an electronic processing unit of an infotainment system of the vehicle, the electronic control unit being adapted to evaluate data from said at least one environment sensor and to transmit at least one of communication messages to the electronic processing unit of the infotainment system and control commands to at least one electronic control unit of the drive system in such a way that the method of claim 11 is performed.
